(19) United States
(12) Patent Application Publication
(10) Pub. No.: US 2012/0243447 A1
(43) Pub. Date: Sep. 27, 2012

(54) DUAL ANTENNA DISTRIBUTED FRONT-END RADIO

(75) Inventors: Haim M. Weissman, Haifa (IL); Avigdor Brillant, Haifa (IL); Rimon Mansour, Haifa (IL); Gene Fong, San Diego, CA (US)

(73) Assignee: QUAL COMM Incorporated, San Diego, CA (US)

(21) Appl. No.: 13/423,743

(22) Filed: Mar. 19, 2012

Related U.S. Application Data
(60) Provisional application No. 61/454,903, filed on Mar. 21, 2011.

(51) Int. Cl. H04B 1/38; H04J 3/00; H04J 1/00; H04L 5/00

(52) U.S. Cl. 370/280; 375/219; 370/297; 370/281

(57) ABSTRACT

Certain aspects of the present disclosure provide a dual antenna distributed radio frequency front end (RFFE). RFFE topologies described herein may provide lower insertion loss (IL), reduced emission mask, decreased power consumption, and/or lower noise figure (NF) compared to conventional RFFE topologies. One example apparatus for wireless communications generally includes first and second power amplifiers (PAs) for amplifying signals for transmission, a transmit antenna for transmitting the amplified signals, a receive antenna for receiving other signals to be processed in a receive path, and a first transmit filter configured to filter the amplified signals from the first PA before amplification by the second PA. For certain aspects, a divided inter-stage filter providing overlapping frequency bands may be utilized. For certain aspects, the RFFE may support frequency-division duplexing (FDD)/TDD (time-division duplexing) coexistence, including support for FDD/TDD MIMO (multiple input multiple output).

### CROSS-REFERENCE TO RELATED APPLICATIONS

This application claims benefit of U.S. Provisional Patent Application Ser. No. 61/454,903, filed Mar. 21, 2011 and entitled “Dual Antenna Distributed Front-End Radio,” which is herein incorporated by reference.

### TECHNICAL FIELD

Certain aspects of the present disclosure generally relate to wireless communications and, more particularly, to a dual antenna distributed front-end radio.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1×RTT (1 times Radio Transmission Technology, or simply 1×), W-CDMA (Wideband Code Division Multiple Access), UMTS-TDD (Universal Mobile Telecommunications System-Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

Certain aspects of the present disclosure provide an apparatus for wireless communications. The apparatus generally includes first and second power amplifiers (PAs) for amplifying signals for transmission, a transmit antenna for transmitting the amplified signals, a receive antenna for receiving other signals to be processed in a receive path, and a first transmit filter configured to filter the amplified signals from the first PA before amplification by the second PA.

For certain aspects, the apparatus further includes a second transmit filter configured to filter the amplified signals from the second PA before transmission by the transmit antenna. The second transmit may have more relaxed rejection than the first transmit filter and may have low insertion loss. For certain aspects, the second PA is a low gain PA.

According to certain aspects, the first transmit filter includes a divided filter, which typically includes at least two selectable filters and at least one switch for selecting between the at least two selectable filters. For certain aspects, the at least two selectable filters have overlapping passbands. For certain aspects, the at least two selectable filters comprise at least one of a surface acoustic wave (SAW) filter, a bulk acoustic wave (BAW) filter, a thin film bulk acoustic resonator (FBAR) filter, or an inductor-capacitor (LC) filter.

For certain aspects, the apparatus further includes a notch filter configured to filter the amplified signals from the first PA before amplification by the second PA. For certain aspects, the notch filter is a tunable notch filter. For certain aspects, the first transmit filter comprises a notch filter.

According to certain aspects, the receive path generally includes first and second low noise amplifiers (LNAs) for amplifying the other signals received by the receive antenna and a first receive filter configured to filter the amplified other signals from the first LNA before amplification by the second LNA. For certain aspects, the apparatus further includes a second receive filter configured to filter the other signals received by the receive antenna before amplification by the first LNA. The second receive filter may have more relaxed rejection than the first receive filter and may have low insertion loss. For certain aspects, the first LNA is a low gain LNA. For certain aspects, the first receive filter comprises a divided filter that typically includes at least two selectable filters and at least one switch for selecting between the at least two selectable filters. For certain aspects, the at least two selectable filters have overlapping passbands. For certain aspects, the at least two selectable filters include at least one of a SAW filter, a BAW filter, a FBAR filter, or an LC filter. According to certain aspects, the apparatus further includes a notch filter configured to filter the amplified other signals from the first LNA before amplification by the second LNA. For certain aspects, the notch filter is a tunable notch filter. For certain aspects, the first receive filter comprises a notch filter.

According to certain aspects, the receive path generally includes a first receive filter configured to filter the other signals received by the receive antenna and a low noise amplifier (LNA) for amplifying the filtered other signals. For certain aspects, the transmit antenna is isolated from the receive antenna by at least 15 dB.

According to certain aspects, the apparatus further includes a transmit diplexer configured to frequency-domain multiplex inputs to first and second ports onto a third port, wherein the first port receives the amplified signals from the second PA and wherein the third port is coupled to the transmit antenna. For certain aspects, the apparatus further includes a third PA for amplifying the amplified signals from the first PA, wherein the amplified signals from the third PA are sent to the second port of the transmit diplexer. For certain aspects, the first transmit filter, the second PA, and a second transmit filter coupled between the first and third ports of the transmit diplexer form a first transmit path that supports frequency-division duplex (FDD) transmission and wherein the third PA and a third transmit filter coupled between the second and third ports of the transmit diplexer form a second transmit path that supports time-division duplexing (TDD). For certain aspects, the first transmit path supports the FDD transmission in a first range from about 3.41 to about 3.49 GHz and wherein the second transmit path supports the TDD in a second range from about 3.6 to about 3.8 GHz. For certain aspects, the receive path supports FDD reception in a third range from about 3.51 to about 3.59 GHz.

According to certain aspects, the apparatus further includes a receive diplexer having first and second ports and configured to frequency-domain de-multiplex an input to a third port onto the first and second ports, wherein the third port receives the other signals from the receive antenna. For certain aspects, the receive path generally includes a switch for selecting between the first and second ports of the receive diplexer and at least one LNA for amplifying the other signals received via the selected one of the first and second ports. For certain aspects, the receive path and a first receive filter coupled between the first and third ports of the receive diplexer support FDD reception in a first range from about 3.51 to 3.59 GHz, and the receive path and a second receive filter coupled between the second and third ports of the receive diplexer support TDD in a second range from about 3.6 to 3.8 GHz.

Certain aspects of the present disclosure provide an apparatus for wireless communications. The apparatus generally includes a receive antenna for receiving signals, a transmit antenna for transmitting other signals processed in a transmission path, first and second low noise amplifiers (LNAs) for amplifying the signals received by the receive antenna, and a first receive filter configured to filter the amplified signals from the first LNA before amplification by the second LNA.

According to certain aspects, the apparatus further includes a second receive filter configured to filter the signals received by the receive antenna before amplification by the first LNA. For certain aspects, the second receive filter has more relaxed rejection than the first receive filter and/or has low insertion loss. For certain aspects, the first LNA is a low gain LNA.

According to certain aspects, the first receive filter comprises a divided filter that typically includes at least two selectable filters and at least one switch for selecting between the at least two selectable filters. For certain aspects, the at least two selectable filters have overlapping passbands. For certain aspects, the at least two selectable filters comprise at least one of a surface acoustic wave (SAW) filter, a bulk acoustic wave (BAW) filter, a thin film bulk acoustic resonator (FBAR) filter, or an inductor-capacitor (LC) filter.

According to certain aspects, the apparatus further includes a notch filter configured to filter the amplified signals from the first LNA before amplification by the second LNA. For certain aspects, the notch filter is a tunable notch filter. For certain aspects, the first receive filter comprises a notch filter. For certain aspects, the receive antenna is a tunable receive antenna.

According to certain aspects, the apparatus supports long-term evolution (LTE) B22 (3.5 GHz band) with frequency division duplexing (FDD). For certain aspects, the apparatus supports a FDD band gap of about 10 MHz. For certain aspects, the transmit antenna is isolated from the receive antenna by at least 15 dB.

Certain aspects of the present disclosure provide an apparatus for wireless communications. The apparatus generally includes a first driver amplifier (DA) for amplifying signals for transmission; a transmit filter for filtering the amplified signals from the first DA; a first power amplifier (PA) for amplifying the filtered signals from the transmit filter; a first diplexer configured to frequency-domain multiplex inputs to first and second ports onto a third port, wherein the first port receives the amplified signals from the first PA; a first antenna coupled to the first PA via a first diplexer; and a second antenna coupled to a receive path via a second diplexer.

According to certain aspects, the first diplexer is configured to frequency-domain multiplex inputs to first and second ports onto a third port, wherein the first port receives the amplified signals from the first PA and wherein the third port is coupled to the first antenna. For certain aspects, the apparatus further includes a second DA for amplifying other signals for transmission and a third PA for amplifying the amplified signals from the second DA, wherein the third PA is coupled to the second port of the first diplexer. For certain aspects, the apparatus further includes a first LNA and a first switch for selecting between the third PA for transmission and the first LNA for reception, wherein the first switch is coupled to the second port of the first diplexer. For certain aspects, the receive path comprises a second LNA, and the second diplexer is configured to frequency-domain multiplex inputs to fourth and fifth ports onto a sixth port, wherein the sixth port is coupled to the second antenna and wherein the fourth port is coupled to the second LNA. For certain aspects, the apparatus further includes a third LNA and a second switch for selecting between the second PA for transmission and the third LNA for reception, wherein the second switch is coupled to the fifth port of the second diplexer. For certain aspects, the apparatus further includes a second switch interposed between the second LNA and the fourth port of the second diplexer and a third switch coupled to the fifth port of the second diplexer, wherein the third switch is for selecting between the second PA for transmission and the second switch for reception by the second LNA and wherein the second switch is for selecting between the fifth port, via the third switch, and the fourth port for reception. For certain aspects, the transmit filter, the first PA, and a portion of the first diplexer including the first port form a first transmit path that supports FDD transmission, and the receive path and a portion of the second diplexer including the fourth port support FDD reception. For certain aspects, the first transmit path supports the FDD transmission in a first range from about 3.41 to about 3.49 GHz, and the receive path and the portion of the second diplexer support the FDD reception in a second range from about 3.51 to about 3.59 GHz. For certain aspects, the third PA, the first switch, and another portion of the first diplexer including the second port support TDD transmission, and the first LNA, the first switch, and the portion of the first diplexer including the second port support TDD reception. For certain aspects, the apparatus supports the TDD transmission and the TDD reception in a third range from about 3.6 to about 3.8 GHz. For certain aspects, the apparatus supports the TDD transmission or the TDD reception simultaneously with the FDD transmission and the FDD reception. For certain aspects, the apparatus supports time-division duplexing (TDD) multiple input, multiple output (MIMO). For certain aspects, the second LNA is a dual-mode LNA.

According to certain aspects, the first DA has a higher gain than the first PA. For certain aspects, at least one of the first and second antennas is a tunable antenna. For certain aspects, the first antenna is isolated from the second antenna by at least 15 dB. For certain aspects, the apparatus supports a FDD band gap of about 20 MHz.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point (AP) and user terminals in accordance with certain aspects of the present disclosure.

FIG. 3 illustrates example Long Term Evolution (LTE) 3.5 GHz frequency band assignments by band number, in accordance with certain aspects of the present disclosure.

FIG. 4 illustrates an example radio frequency front end (RFFE) block diagram using a duplexer, in accordance with certain aspects of the present disclosure.

FIG. 5 illustrates an example RFFE block diagram using a distributed transmitter, in accordance with certain aspects of the present disclosure.

FIG. 6 illustrates an example RFFE block diagram using a distributed receiver, in accordance with certain aspects of the present disclosure.

FIG. 7 illustrates an example RFFE block diagram using a distributed transmitter/receiver (Tx/Rx) and a dual transmit/receive (Tx/Rx) antenna, in accordance with certain aspects of the present disclosure.

FIG. 8 illustrates an example RFFE block diagram using a divided inter-stage filter, in accordance with certain aspects of the present disclosure.

FIG. 9 illustrates overlapping frequency bands for a divided inter-stage filter, in accordance with certain aspects of the present disclosure.

FIG. 10 illustrates an example approach to split LTE Band #22 (B22) with a divided inter-stage filter, according to the European Union (EU) Plan and using the frequency bands of FIG. 9, in accordance with certain aspects of the present disclosure.

FIG. 11 illustrates an example RFFE block diagram using a trap/notch inter-stage filter, in accordance with certain aspects of the present disclosure.

FIG. 12 illustrates an example RFFE block diagram using distributed Tx/Rx paths with dual tunable antennas, in accordance with certain aspects of the present disclosure.

FIG. 13 illustrates an example RFFE block diagram using a distributed Tx path with dual tunable antennas, in accordance with certain aspects of the present disclosure.

FIGS. 14A and 14B illustrates example RFFE block diagrams for LTE B22 frequency-division duplex (FDD) split systems with a 20 MHz duplex band gap, in accordance with certain aspects of the present disclosure.

FIG. 15 illustrates example frequency bands for coexistence of frequency division duplexing (FDD) and time division duplexing (TDD) in a LTE 3.5 GHz system, in accordance with certain aspects of the present disclosure.

FIG. 16A illustrates an example RFFE block diagram for FDD/TDD coexistence using a common antenna, in accordance with certain aspects of the present disclosure.

FIG. 16B illustrates an example dual antenna RFFE block diagram for FDD/TDD coexistence using a distributed transmitter and two diplexers, in accordance with certain aspects of the present disclosure.

FIG. 16C is a table illustrating a part count summary for comparing part counts between the RFFE block diagrams of FIGS. 16A and 16B, in accordance with certain aspects of the present disclosure.

FIG. 17A illustrates an example RFFE block diagram for FDD/TDD MIMO (multiple input multiple output) coexistence, expanding on the RFFE block diagram of FIG. 16A, in accordance with certain aspects of the present disclosure.

FIG. 17B illustrates an example RFFE block diagram for FDD/TDD MIMO coexistence using two diplexers, expanding on the RFFE block diagram of FIG. 16B, in accordance with certain aspects of the present disclosure.

FIG. 17C is a table illustrating a part count summary for comparing part counts between the RFFE block diagrams of FIGS. 17A and 17B, in accordance with certain aspects of the present disclosure.

FIG. 18 illustrates an example RFFE block diagram for FDD/TDD MIMO coexistence using two diplexers, as an alternative to the RFFE block diagram of FIG. 17B, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE), or some other standards. A TDMA system may implement GSM or some other standards. These various standards are known in the art.

### An Example Wireless System

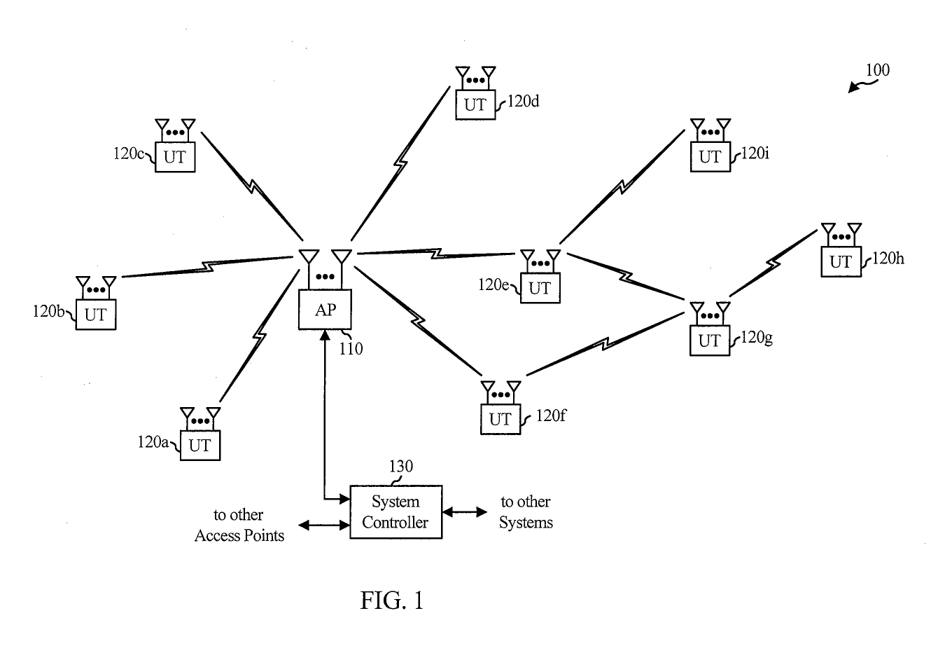

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ, of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

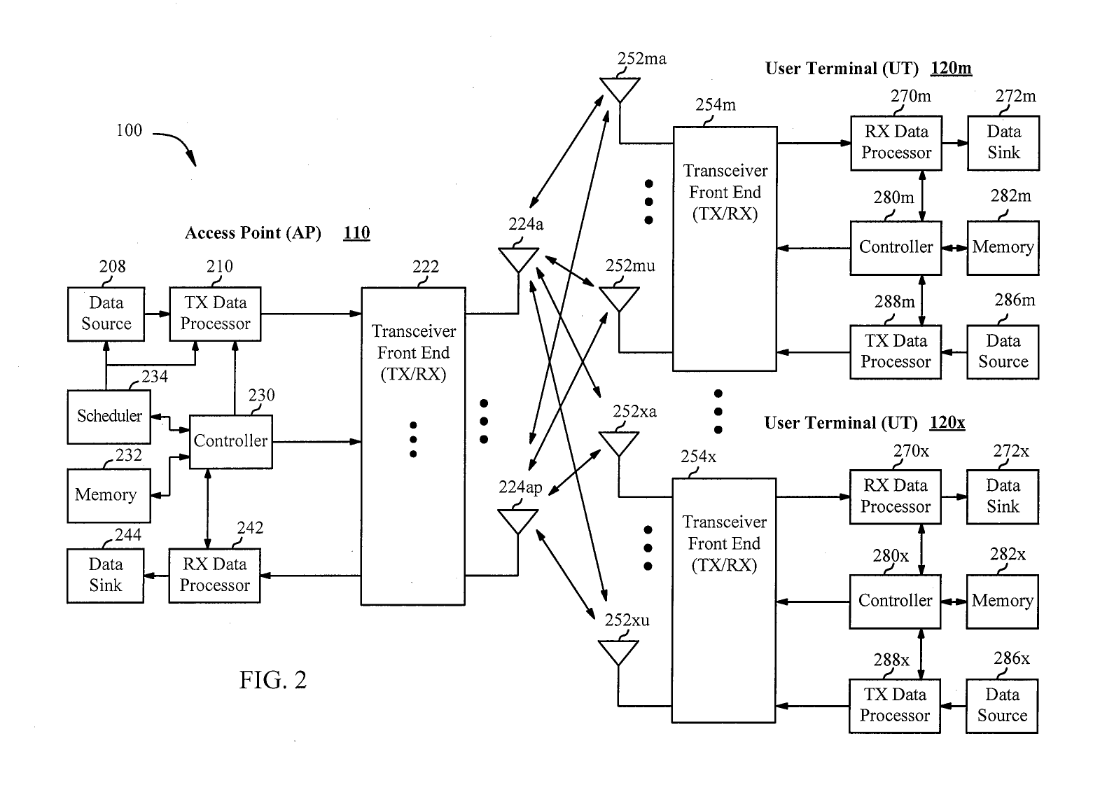

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254.

A number Nᵤₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222.

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, and combinations thereof.

### An Example Dual Antenna Distributed Front-End Radio

Conventional frequency-division duplex (FDD) full-duplex handset radio front-end design may suffer from realization problems. These problems may occur because of close frequency duplex separation specifications between transmission (Tx) (uplink (UL)) and reception (Rx) (downlink (DL)). Severe tradeoffs may be made between pass band insertion loss (IL) and Tx-Rx rejection specifications. For example, small form factor filters may be very difficult to realize with small duplex band gaps. This may result in high Tx path insertion loss, reduced Tx power efficiency, and a larger emission mask due to higher power amplifier (PA) output power and higher PA drive. This may also result in high Rx path insertion loss and a higher noise figure (NF). Compromising on filter performance may likely affect the self-desensitization on Rx, and Tx emissions may likely increase. The problem and various solutions are described herein with respect to the LTE band 22 (B22) case, although the ideas may be applied to other bands and RATs, as well.

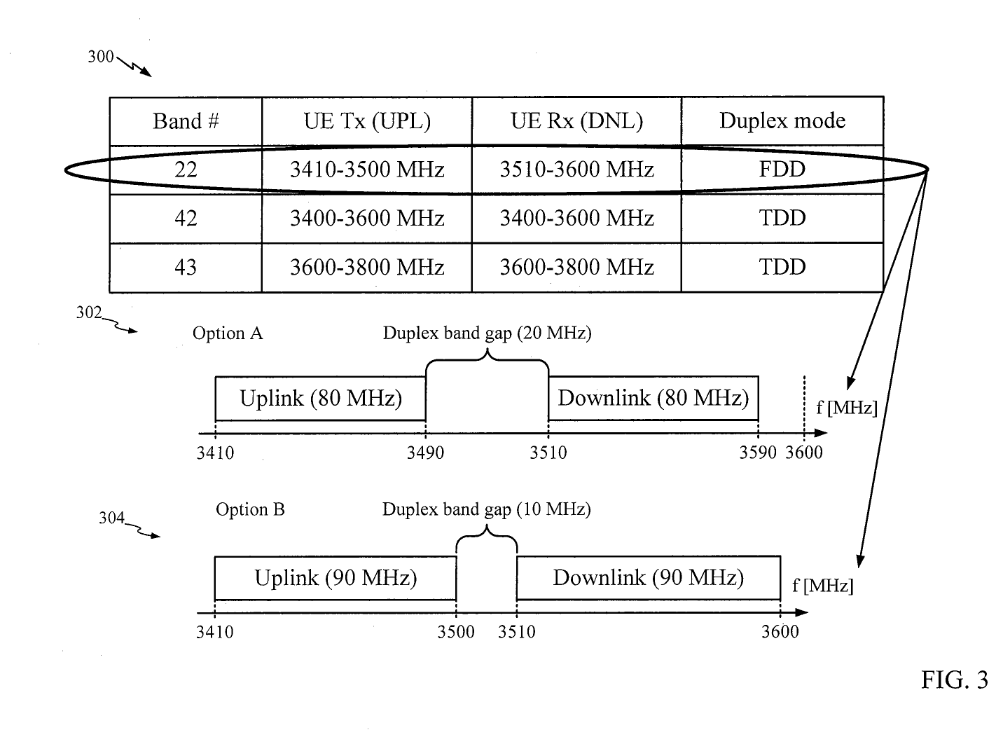

FIG. 3 illustrates a table 300 of example LTE 3.5 GHz frequency band assignments by band number. 3GPP TR 37.801 V0.10.0 (2011-01)—Paragraph 8.1.1 provides frequency band assignments for bands 22, 42, and 43, as illustrated in FIG. 3. For B22, at least two baseline options 302, 304 for uplink/downlink pairing assignment for FDD may exist. In a first option 302 (Option A), a 20 MHz duplex band gap may exist between an 80 MHz UE uplink frequency band (spanning frequencies from 3410 MHz to 3490 MHz) and an 80 MHz UE downlink frequency band (spanning frequencies from 3510 MHz to 3590 MHz). In a second option 304 (Option B), a 10 MHz duplex band gap may exist between a 90 MHz UE uplink frequency band (spanning frequencies from 3410 MHz to 3500 MHz) and a 90 MHz UE downlink frequency band (spanning frequencies from 3510 MHz to 3600 MHz).

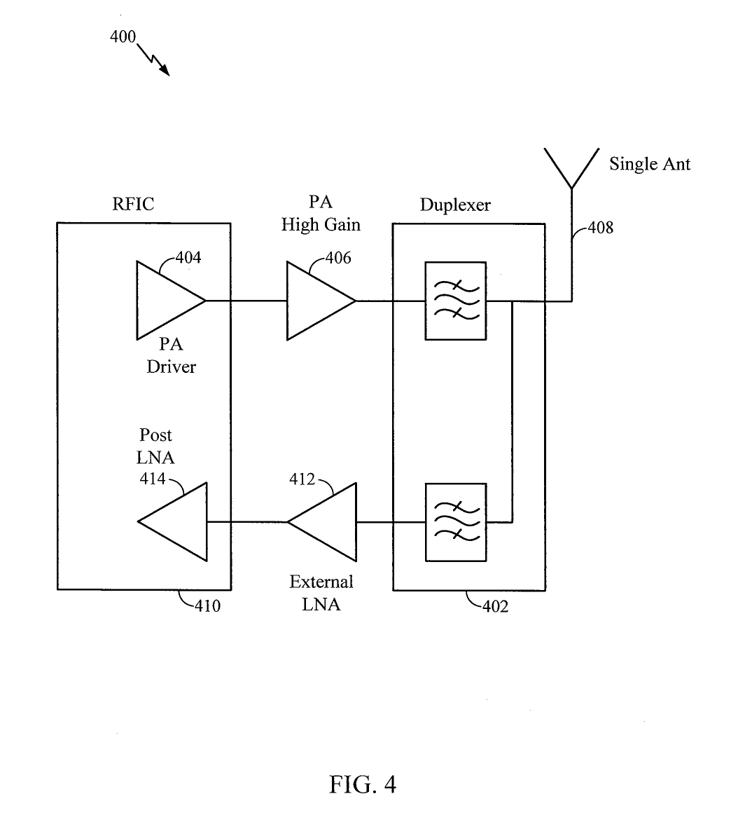

FIG. 4 illustrates an example radio frequency front end (RFFE) block diagram 400 using a duplexer 402, which may entail several implementation problems for LTE B22. A duplexer (or duplexing assembly) is a device that permits bi-directional (duplex) communication over a single channel, isolating the transmitter from the receiver, but allowing them to share a common antenna. For RF transmission, the transmission path of the RFFE block diagram 400 comprises a power amplifier (PA) driver 404 driving a high gain PA 406, whose amplified signal is sent to a first port of the duplexer 402, where the amplified signal is frequency filtered and sent via a second port of the duplexer 402 to a common antenna 408. The PA driver 404 may be implemented in a radio frequency integrated circuit (RFIC) 410. For RF reception, the receive path comprises the common antenna 408, the duplexer 402, an external low noise amplifier (LNA) 412, and a post LNA 414, which may be implemented in the RFIC 410. Wireless signals received by the common antenna 408 may be frequency filtered in the duplexer 402 and sent via a third port of the duplexer 402 to the external LNA 412 for amplification. The amplified signals from the external LNA 412 may be sent to the post LNA 414 for further amplification.

Advantages of the RFFE block diagram 400 include use of a single antenna, simple implementation, and low part count. However, a 10 MHz Tx/Rx duplex band gap may not be feasible in a handset due to its RFFE duplexer realization, stringent speciation due to 10 MHz Tx/Rx separation, high insertion loss (IL), and too many sections. Furthermore, this architecture may have a high noise figure (NF), high Tx gain to compensate Tx loss, and high power consumption. Also with this RFFE topology, Rx sensitization by the Tx wideband (WB) noise and Tx power may entail a very high third-order intercept point (IP3) LNA and Rx lineup. The higher drive of the PA 406, which may be implemented in an effort to compensate for RFFE Tx BPF loss, may result in spectral re-growth and spectral mask deficit to comply with adjacent and alternate channel design constraints. The PA 406 may have a lower drive because of a second BPF lower IL and lower out-of-band (OOB) noise level.

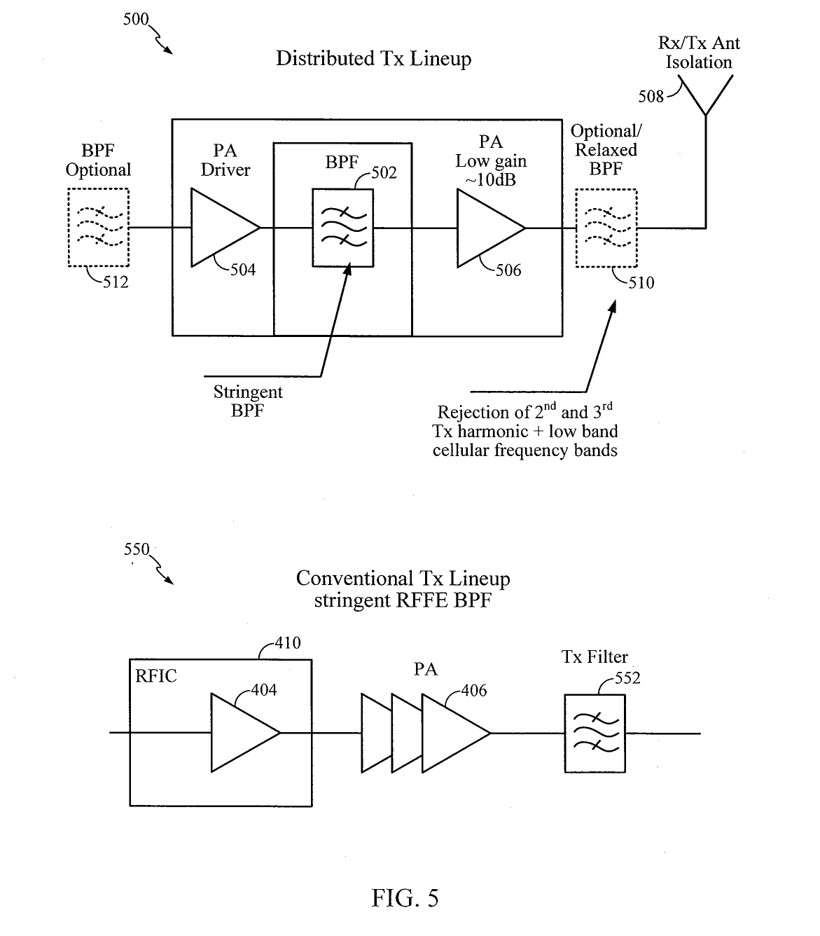

FIG. 5 illustrates an example RFFE block diagram 500 using a distributed transmitter (Tx), in accordance with certain aspects of the present disclosure, as compared to a conventional Tx lineup 550. In the conventional Tx lineup 550, a Tx BPF 552 with very stringent rejection requirements is used to filter out OOB noise from the transmission path, up to and including one or more cascaded PAs 406 used to achieve high gain.

In the distributed Tx lineup of FIG. 5, an inter-stage BPF 502 may be located between a PA driver 504 and a low gain (˜10 dB) PA 506. Front end (FE) isolation may be achieved by Tx/Rx antenna isolation (i.e., one antenna 508 is used for the transmission path, while another antenna (not shown) is used for the reception path). For some embodiments, the duplexer 402 may be replaced with an optional BPF 510, which may be configured to reject second and third harmonics and low cellular frequency bands. Tx/Rx antenna isolation may allow for either relaxing the RFFE band pass filter (BPF) rejection or removing the BPF 510 between the antenna 508 and the PA 506 altogether. A distributed front-end BPF (e.g., inter-stage BPF 502 and optional BPF 510) is described in U.S. Pat. No. 6,795,690, entitled “Full-Duplex Transceiver with Distributed Duplexing Function” and commonly owned with the present application, herein incorporated by reference in its entirety.

Removing the BPF 510 has the added advantage of lower insertion loss (IL), which leads to lower FE loss due to voltage standing wave ratio (VSWR) mismatch and a lower PA drive. Lower PA drive may offer an improved PA emission mask, OOB Tx noise being rejected, lower current consumption, and 2^{nd} harmonic rejection. Further rejection may be achieved with the inter-stage BPF 502, which may reject Tx OOB noise generated and amplified by the Tx path up to and including the PA driver 504 and reject harmonics at the input to the PA 506. The inter-stage BPF 502 may have stringent rejection design constraints. The distributed Tx lineup may also include an optional BPF 512 before the PA driver 504. Further Tx noise rejection may be accomplished by a pre-PA driver for removing modulator noise and mixer harmonics.

According to certain aspects of the present disclosure, a first Tx filter (e.g., the inter-stage Tx filter 502) may be configured to filter the amplified signal from a first PA (e.g., the PA driver 504) before amplification by a second PA (e.g., the low gain PA 506). The Tx filter may comprise a BPF filter that may have a relaxed or a more stringent specification. The Tx filter may be a surface acoustic wave (SAW) filter, bulk acoustic wave (BAW) filter, thin film bulk acoustic resonator (FBAR) filter, inductor-capacitor (LC) filter, or any other type of suitable filter. For certain aspects, an optional Tx analog base-band (ABB) filter (e.g., BPF 512) before the first PA may be configured to add additional Tx noise reduction of the Tx modulator and ABB gain which may leak into Rx prior to amplification by the first PA.

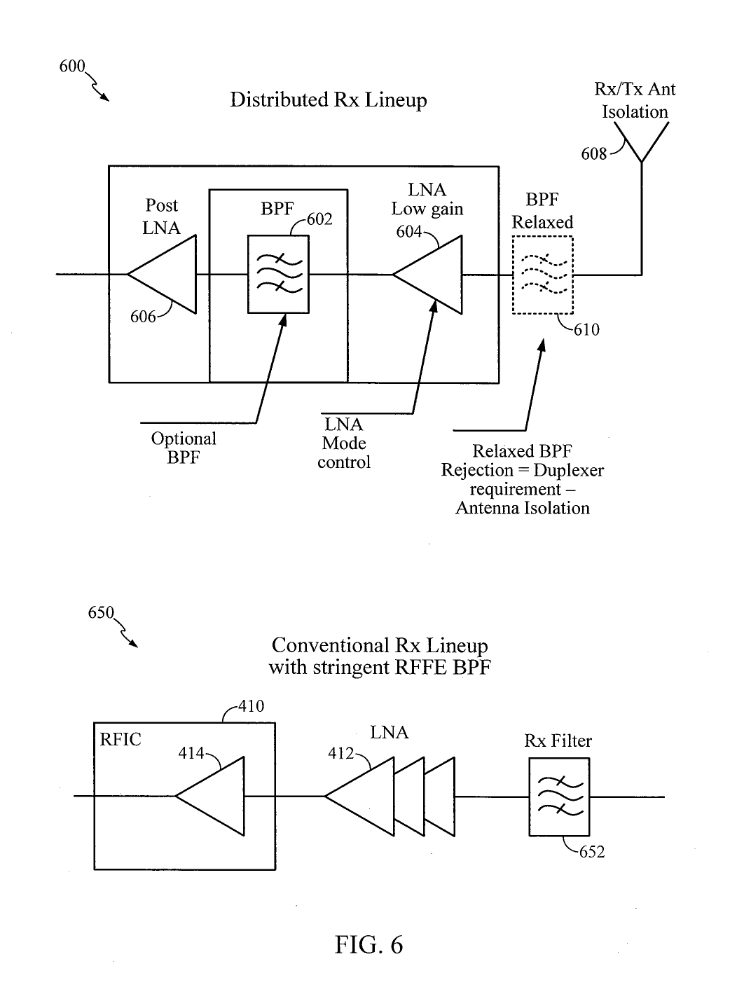

FIG. 6 illustrates an example RFFE block diagram 600 using a distributed receiver (Rx), in accordance with certain aspects of the present disclosure, as compared to a conventional Rx lineup 650. In the conventional Rx lineup 650, an Rx BPF 652 with very stringent rejection requirements filters OOB signals received via the Rx antenna from the reception path, which includes one or more cascaded LNAs 412.

In the distributed Rx lineup of FIG. 6, an optional inter-stage BPF 602 may be located between a low gain LNA 604 and a post LNA 606. Low LNA gain at the FE may prevent LNA compression from Tx leakage. LNA linearity for high Tx power may be controlled by LNA bias mode control (switching between high linearity and low linearity modes). A dual-mode LNA (e.g., LNA 604) is described in U.S. Pat. No. 6,795,690, entitled “Full-Duplex Transceiver with Distributed Duplexing Function” and commonly owned with the present application, herein incorporated by reference in its entirety. FE isolation may be achieved by Tx/Rx antenna isolation (i.e., one antenna 608 is used for the reception path, while another antenna (not shown) is used for the transmission path). Tx/Rx antenna isolation may allow for either relaxing the RFFE BPF rejection or removing the BPF 610 between the antenna 608 and the LNA 604 altogether. Removing the BPF 610 has the added advantage of lower IL, which leads to lower FE loss due to VSWR mismatch and improved NF. Further rejection of undesired signal and noise may be achieved with the inter-stage BPF 602, which may reject Tx power and prevent Rx compression.

According to certain aspects of the present disclosure, a second Rx inter-stage filter may be configured to reject unwanted jammers/blocking interfering signals and transfer wanted signals received by the receive antenna before amplification by a LNA. According to certain aspects, the second Rx filter may have more stringent rejection criteria than the first Rx filter. According to certain aspects, the first Rx filter may have low IL, resulting in lower NF in the Rx path by the amount of IL. According to certain aspects, the first LNA may be a low gain LNA, which may result in higher Rx IP3, P1dB (1 dB compression point), and Rx immunity against unwanted jammers/blocking interfering signals. According to certain aspects, the second Rx filter may protect the second LNA and prevent its compression by unwanted jammers/blocking interfering signals. The second Rx filter may have stringent specifications and significantly reduce unwanted jammers/blocking interfering signals prior to amplification by the second LNA, and the second Rx filter may also prevent Rx mixer and ABB compression and suffering from second-order intercept point (IP2) noise and DC effects without degrading the Rx NF.

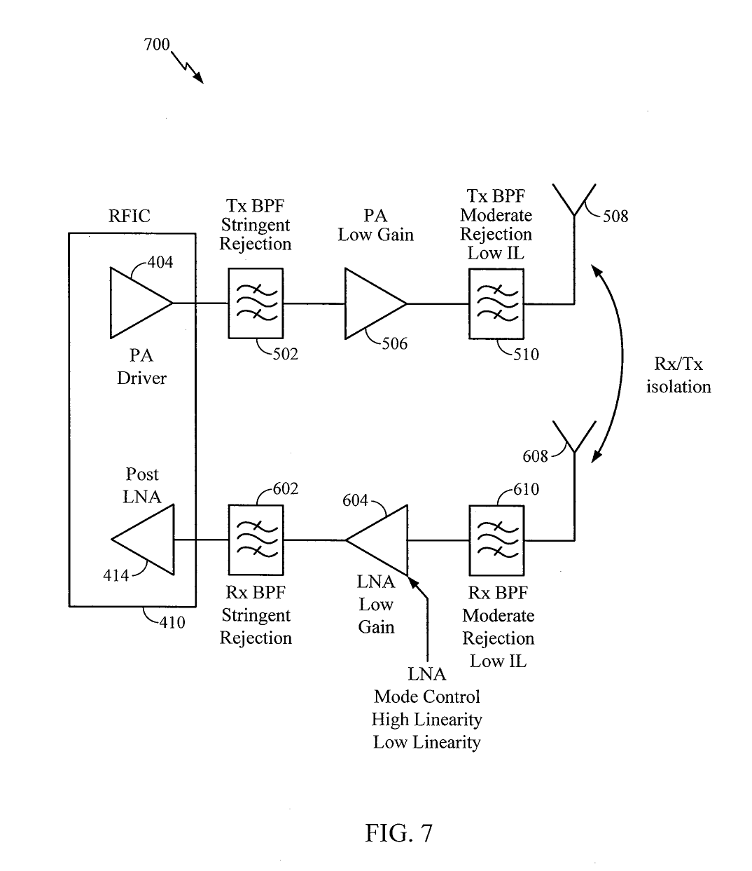

FIG. 7 illustrates an example RFFE block diagram 700 using a distributed transmitter/receiver (Tx/Rx) with dual transmit/receive (Tx/Rx) antennas, in accordance with certain aspects of the present disclosure. In the RFFE block diagram 700, certain aspects of FIGS. 4, 5, and 6 are combined as shown. Dual (tunable) Tx/Rx antennas with high isolation (e.g., Tx antenna 508 and Rx antenna 608) are described in U.S. Pat. No. 7,801,556, entitled “Tunable Dual-Antenna System for Multiple Frequency Band Operation” and commonly owned with the present application, herein incorporated by reference in its entirety.

Notwithstanding the disadvantage of employing dual antennas, the RFFE architecture shown in FIG. 7 has several advantages. For example, this architecture may provide for Rx/Tx antenna isolation (e.g., of at least about 15 dB), with no need to split the Rx/Tx band. Using a distributed BPF lineup may reduce the Tx-to-antenna loss and NF degradation and may also provide the desired linearity. This RFFE architecture may also allow the rejection specification for the filters to be relaxed to approximately 35 dB instead of the typical 45-50 dB duplexer rejection design constraint. This architecture need not involve additional control, thereby offering a simple solution, and may support the option to add LNA current mode or gain mode. Despite these advantages, the relaxed filters' specifications may still have too great an IL at the RFFE for a 10 MHz band gap in FDD.

According to certain aspects of the present disclosure, a dual Tx/Rx antenna integrated with a distributed FE may offer other advantages. For example, dual Tx/Rx tunable antennas may permit deletion of the duplexer 402. This may result in 2-3 dB of Tx power savings by almost directly feeding the low gain PA 506 to the Tx antenna 508 (IL of the relaxed optional BPF 510 is on the order of 0.5 dB), thereby saving the duplexer's IL. The dual Tx/Rx tunable antennas may allow for separately tuning the Tx and Rx antennas 508, 608, which may achieve better Tx and Rx antenna gain features and additional rejection in the Tx and Rx chains.

The 2-3 dB of Tx power saving by almost directly feeding the low gain PA 506 to the Tx antenna 508 (of the dual Tx/Rx antennas) may also be achieved by using non-tunable dual Tx/Rx antennas 508, 608. In the case of non-tunable dual Tx/Rx antennas, the relaxed Tx BPF may be optional, and the IL may be on the order of 0.5 dB, while the duplexer IL savings may be on the order of 3 dB. Therefore, using non-tunable dual Tx/Rx antennas may result in an overall power savings on the order of 2.5 dB.

Dual Tx/Rx antennas integrated with distributed FEs may also provide an additional Tx VSWR insertion loss savings of approximately 3.5 dB (duplexer−antenna VSWR mismatch) in addition to duplexer passband IL savings of 2-3 dB.

In the RFFE block diagram 700 of FIG. 7, the duplexer Tx and Rx filters rejection is distributed between the Tx BPF 510 and the Rx BPF 610. The dual Tx/Rx antennas Tx-to-Rx isolation may be approximately 15 to 25 dB. The relaxed inter-stage filters rejection may equal the duplexer isolation minus the antenna Tx/Rx isolation.

The PA is also distributed in the RFFE block diagram 700 of FIG. 7. The low gain PA 506 may directly feed the dual antennas' Tx port, thereby saving 2-3 dB of PA output power that would otherwise be utilized for overcoming duplexer IL and duplexer/antenna VSWR insertion loss of approximately 3.5 dB. Thus, the PA Tx emission mask may be reduced since PA power may be lowered by at least 2 dB. Also with the distributed PA, PA driver broadband noise in the Rx band may be rejected by the inter-stage Tx BPF 502.

Another advantage of dual Tx/Rx antennas integrated with the distributed FE may be a distributed LNA. The distributed LNA may result in lower receiver NF on the order of 1.5 dB due to using a relaxed pre-LNA filter (e.g., the Rx BPF 610) instead of a duplexer, which may suffer from high IL.

Another advantage of dual Tx/Rx antennas integrated with a distributed FE Tx chain may be that the first Rx FE filter (e.g., the Rx BPF 610) rejection design specification may be relaxed to approximately 20 to 35 dB. Therefore, the Rx FE filter IL may be significantly lowered, and overall Rx chain NF may be improved to about 1 dB when using a non-split LNA in the Rx chain.

The receiver NF may be further improved by using a split LNA (i.e., a distributed LNA). The first LNA with very low gain (e.g., LNA 604) may be protected from the Tx noise leakage and self-jamming by the antenna isolation (same as with the non-split LNA case) and further by the relaxed Rx FE filter rejection due to the lower gain first LNA. The first LNA may be protected from “off the air” jammers by the first Rx filter (e.g., Rx BPF 610). The first LNA may have two modes of operation in order to further immunize itself (high linearity mode may be activated) against “off the air” jammers and against self-jamming (Tx-to-Rx chains at high transmit power), as well. The split LNA inter-stage filter (e.g., inter-stage BPF 602) may protect the second LNA (e.g., post LNA 414) both from self-jamming and “off the air” jammers.

The receiver chain (i.e., receive path or reception path) may be protected from self-blocking/desensitization by antenna isolation (e.g., on the order of 15 dB) and by the distributed LNA with inter-stage filters. By adding an inter-stage filter (inter-stage BPF 502), the accumulated OOB noise and harmonics generated by baseband (BB) and a first PA (e.g., PA driver 404) may be filtered prior to amplification by a second PA (e.g., low gain PA 506). The inter-stage filter may be configured to reject unwanted jammers/blocking interfering signals received by the receive antenna. A LNA may amplify both wanted and unwanted jammers/blocking interfering signals. Tx and Rx antennas may be matched as resonator antennas with filter characteristics. The LNA 604 may be protected from self-blocking by the antenna Tx-to-Rx isolation and by the Rx BPF 610. The LNA may have two modes of operation: high linearity and low linearity. In case of high Tx power, the Rx chain immunity may be improved by instantaneous operation at high linearity mode. The LNA high linearity mode may provide better immunity against in-band and out-off-band Rx jammers (blockers).

Furthermore, the dual Tx/Rx antennas integrated with the distributed FE (as illustrated in FIG. 7) may provide significant power consumption savings (such that higher efficiency is achieved), reduced emission mask due to lower output power, and improved sensitivity (on the order of approximately 1.5 dB). An LNA with dual Tx/Rx antennas may provide higher Rx linearity when there may be high-power Tx activity and Rx susceptibility to unwanted jammers/blocking interfering signals.

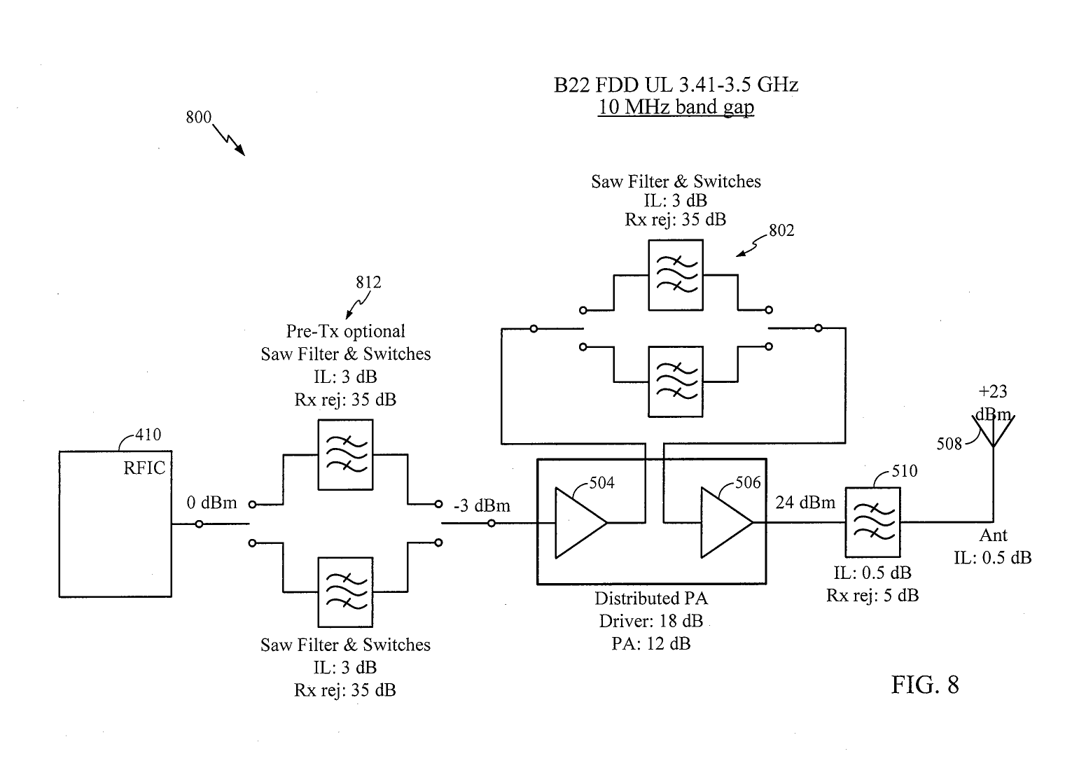

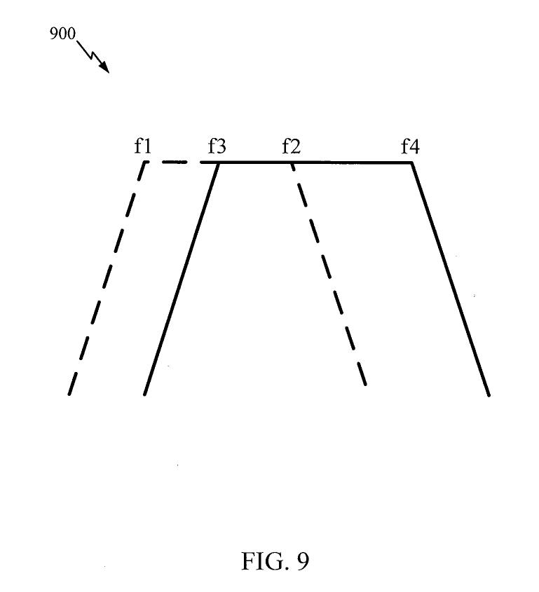

FIG. 8 illustrates an example RFFE block diagram 800 using a divided inter-stage filter 802 (e.g., a BPF), according to certain aspects of the present disclosure. The divided inter-stage filter 802 and associated RF switches may replace the inter-stage BPF 502 of FIG. 5. A duplex band gap of 10 MHz may provide approximately 10 to 15 dB Rx/Tx antenna isolation using a tuned antenna. The filter design constraints may be feasible. For example, a single relaxed BPF 510 may be used to protect against Tx path leakage of wideband (WB) noise and power into the Rx path. A divided filter 802 with frequency band overlap (as shown in FIG. 9) may be used as an inter-stage filter. For certain aspects, a pre-PA-driver Tx divided filter 812 may be used for additional Tx noise reduction. This second divided filter 812 is typically external to the RFIC 410. As described above, the filters 802, 812 may comprise a surface acoustic wave (SAW) filter, bulk acoustic wave (BAW) filter, thin film bulk acoustic resonator (FBAR) filter, inductor-capacitor (LC) filter, or any other type of suitable filter.

FIG. 9 illustrates overlapping frequency bands 900 for a divided inter-stage filter (e.g., filters 802, 812 of FIG. 8), in accordance with certain aspects of the present disclosure. A first frequency band may have cutoff frequencies f1 and f2, while a second frequency band may have cutoff frequencies f3 and f4 and overlap the first frequency band.

The split-band BPF approach demonstrated in FIGS. 8-9 may provide significant BPF realization relaxation. This may be because even though the duplex band gap may be only 10 MHz, as in the LTE B22 example, the band split may create a wider gap. As a result, BPF rejection specifications may be further relaxed, but may nevertheless provide the desired rejection, which may still be greater than a single filter with a 10 MHz duplex band gap.

FIG. 10 illustrates an example approach to split B22 with a divided inter-filter (e.g., filters 802, 812 in FIG. 8), according to the European Union (EU) plan and using the overlapping frequency bands 900 of FIG. 9, in accordance with certain aspects of the present disclosure. A divided inter-stage filter with overlapping frequency bands may provide a solution to the frequency mapping problem. Certain aspects of the present disclosure provide two Rx BPFs: BPF1 ranging from 3.405 to 3.455 GHz (f1-f2) and BPF2 ranging from 3.435 to 3.5 GHz (f3-f4), as shown in FIG. 10. Certain aspects of the present disclosure provide two Tx BPFs: BPF1 ranging from 3.505 to 3.555 GHz (f1-f2), and BPF2 ranging from 3.535 to 3.6 GHz (f3-f4).

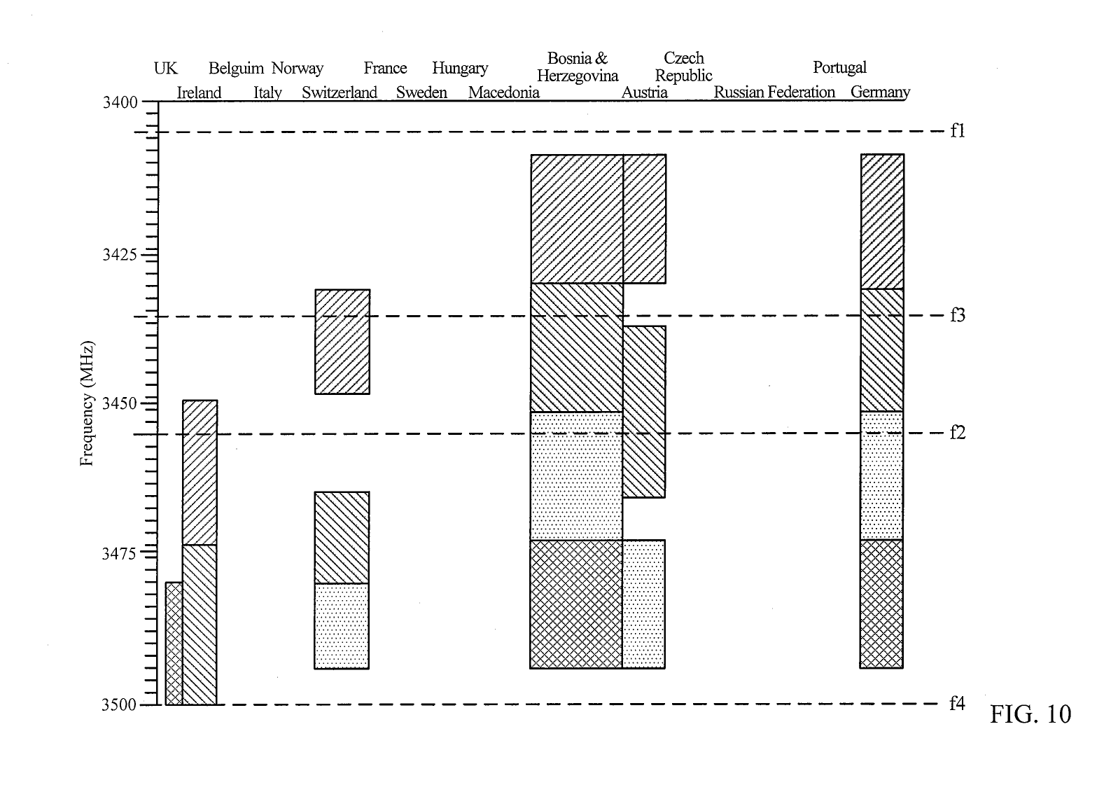

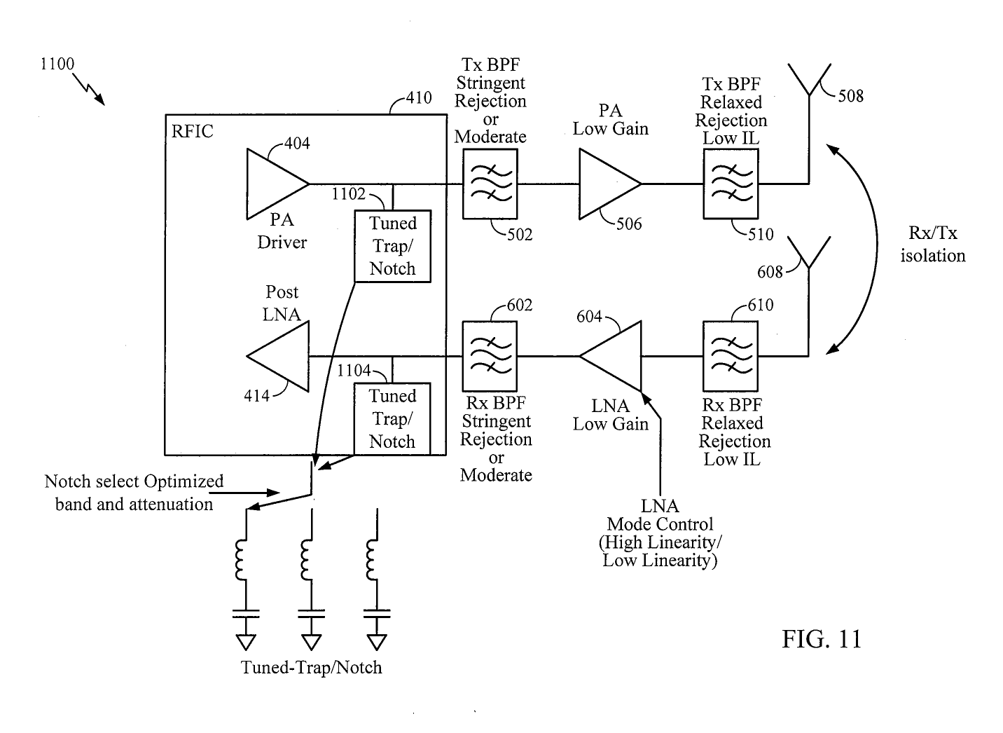

FIG. 11 illustrates an example RFFE block diagram 1100 using a trap/notch inter-stage filter 1102, 1104, according to certain aspects of the present disclosure. This approach may involve adding a tunable trap/notch filter 1102, 1104, within the RFIC 410 or external thereto. The tunable trap/notch filter 1104 for the Rx path may be between the LNA 604 and the post LNA 414, and the tunable trap/notch filter 1102 for the Tx path may be between the PA driver 404 and the PA 506. For certain aspects, one or both of the tunable trap/notch filters 1102, 1104 may comprise a switch for selecting between components (e.g., a series inductor and capacitor) with fixed values. For other aspects, one of the components may be tunable.

Specifications for the inter-stage BPFs 502, 602 may be relaxed or may be kept stringent with the introduction of the trap/notch filters 1102, 1104. The notch inter-stage filter approach may include a relaxed front-end filter (e.g., BPF 510 in the Tx path and BPF 610 in the Rx path), which may permit lower power drive to the PA 506 and, thus, better mask emission in the Tx path. In the Rx path, a front-end filter (e.g., BPF 610) with relaxed specifications may improve Rx NF and, thus, sensitivity.

A tuned trap/notch filter may optimize, or at least increase, frequency rejection within the Rx-Tx band gap. Selection of the frequency band and attenuation for this optimization may be based on the Rx/Tx frequency of operation and/or the LTE resource block (RB) allocation and mode of operation. A tuned trap/notch filter may also permit a relaxed specification for the FE BPF rejection, which may reduce IL. This may save power in the Tx path and/or improve NF in the Rx path.

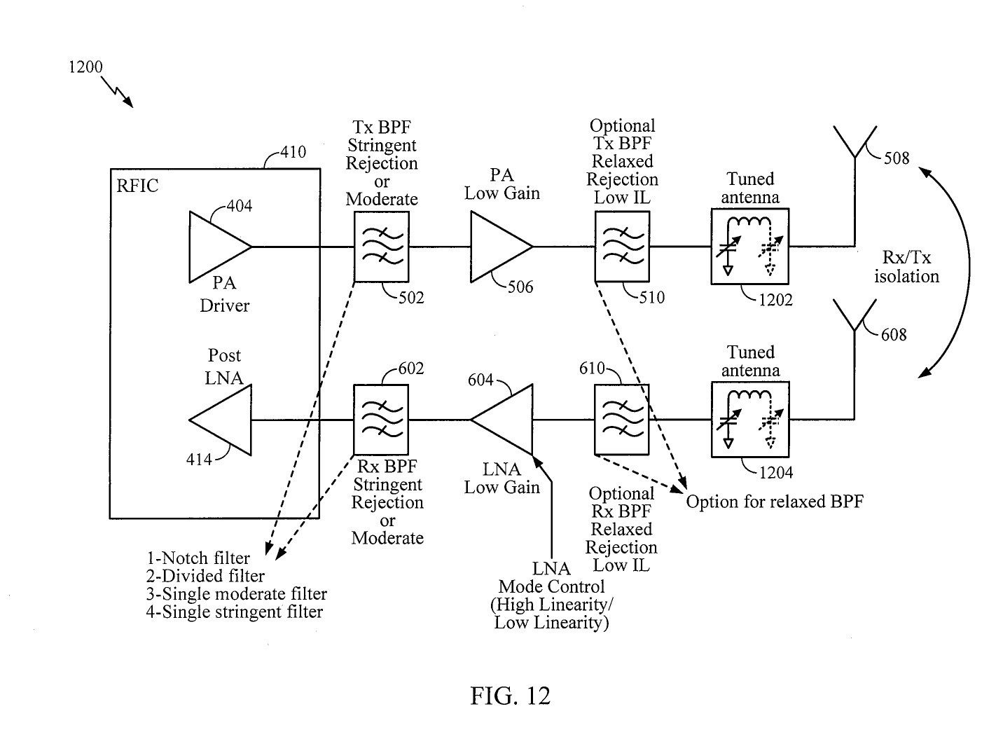

FIG. 12 illustrates an example RFFE block diagram 1200 using distributed Tx/Rx paths with dual tunable antennas, in accordance with certain aspects of the present disclosure. Using tuning circuits 1202, 1204 to tune the antennas 508, 608 may allow optimizing, or at least adjusting, Tx and Rx gains separately, thereby increasing antenna efficiency compared to a single antenna case. A tunable antenna may provide optimized, or at least increased, Tx/Rx antenna isolation. The tuned antennas may provide for increased matching based on Rx/Tx frequency of operation and may enable relaxed specifications for FE BPF rejection or even removal of the FE BPF, thereby reducing IL. This may save power in the Tx path and/or improve NF in the Rx path.

In the RFFE topology of FIG. 12, the inter-stage BPF 602 (between the LNA 604 and the post LNA 414) in the Rx path or the inter-stage BPF 502 (between the PA driver 404 and the PA 506) in the Tx path may comprise a trap/notch filter, a divided filter, a single filter with moderate design constraints, a single filter with stringent design constraints, or any combination thereof. Certain aspects of the present disclosure may provide an inter-stage divided filter (split band) with band overlap for the BPF 602 in the Rx path and an inter-stage divided filter (split band) with band overlap for the BPF 502 in the Tx path. Inter-stage BPF rejection specifications may provide for increased rejection. For certain aspects, the divided inter-stage filter may support a wider duplex band gap and permit stringent rejection. Inter-stage BPF rejection may not affect Rx NF or Tx loss at the antenna.

Combining a tuned antenna with a distributed BPF architecture while employing an inter-stage divided filter (split band) with band overlap may provide for a stringent 10 MHz duplex band gap without degrading Rx NF and reducing Tx efficiency. Further isolation may be achieved by also using tunable Tx/Rx trap/notch filters.

With respect to the FE filters, tuned antennas combined with divided inter-stage filters may relax the design constraints for the FE filters. One advantage of a relaxed front-end filter (no need for a divided filter) includes providing additional Tx rejection against Tx WB noise and power leakage to Rx. This leads to lower power drive to the PA (thus, better mask emission), and a LNA filter with relaxed specification may improve Rx NF and, thus, sensitivity. One disadvantage of the FE filter may be that the dual antennas may provide at least 15 dB (e.g., approximately 25 dB) isolation, which may increase if the duplex band gap is changed to 20 MHz. For certain aspects, the front-end filter may be removed since Rx NF and Tx IL may be higher compared to a no-FE-filter option.

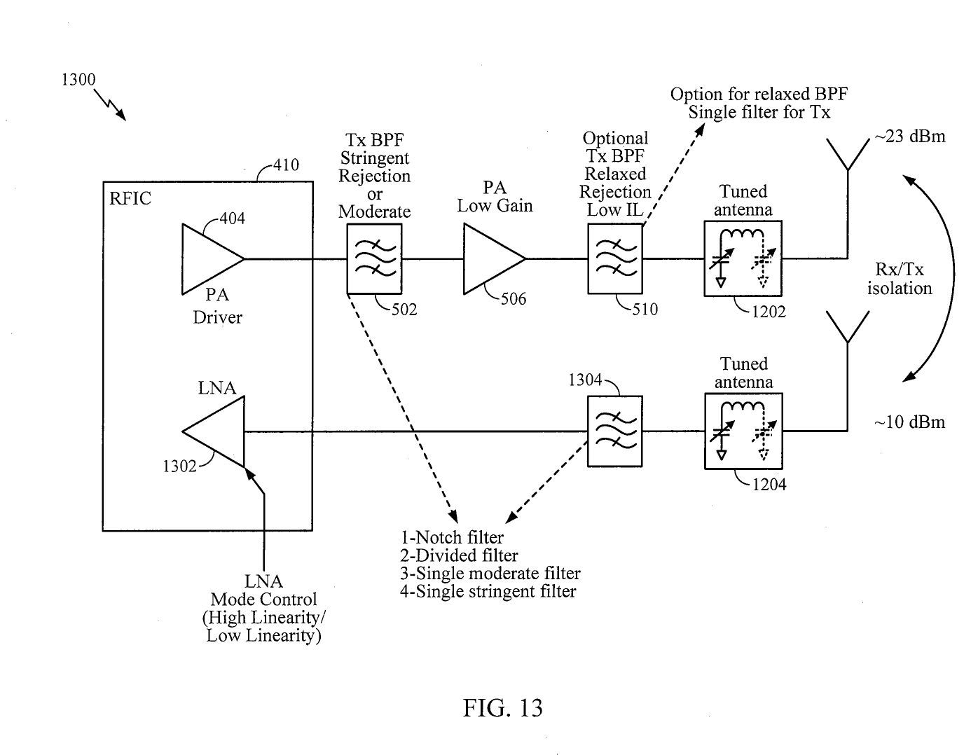

FIG. 13 illustrates an example RFFE block diagram 1300 using a distributed Tx path with dual tunable antennas, in accordance with certain aspects of the present disclosure. In this topology, the Rx path is not distributed. According to certain aspects, a tuned antenna may provide at least 15 dB (typically about 20 to 25 dB isolation), with a maximum power Tx of about 23 dBm and leakage to the Rx antenna port of about 10 dBm.

In the Rx path, a front-end Rx BPF 1304 may function similar to and share characteristics with the inter-stage BPF 602 described above with respect to several aspects. Since there is only one amplifier stage (i.e., LNA 1302) in the topology of FIG. 13, the Rx BPF 1304 is not considered as an inter-stage BPF. The Rx BPF 1304 may comprise a trap/notch filter, a divided filter, a single filter with moderate design constraints, a single filter with stringent design constraints, or any combination thereof A stringent front-end Rx divided filter may add additional Tx rejection against Tx WB noise and power leakage to Rx and allow for a single (in-chip) LNA (e.g., LNA 1302 in RFIC 410). However, a stringent front-end Rx divided filter may result in a degraded Rx NF and IL.

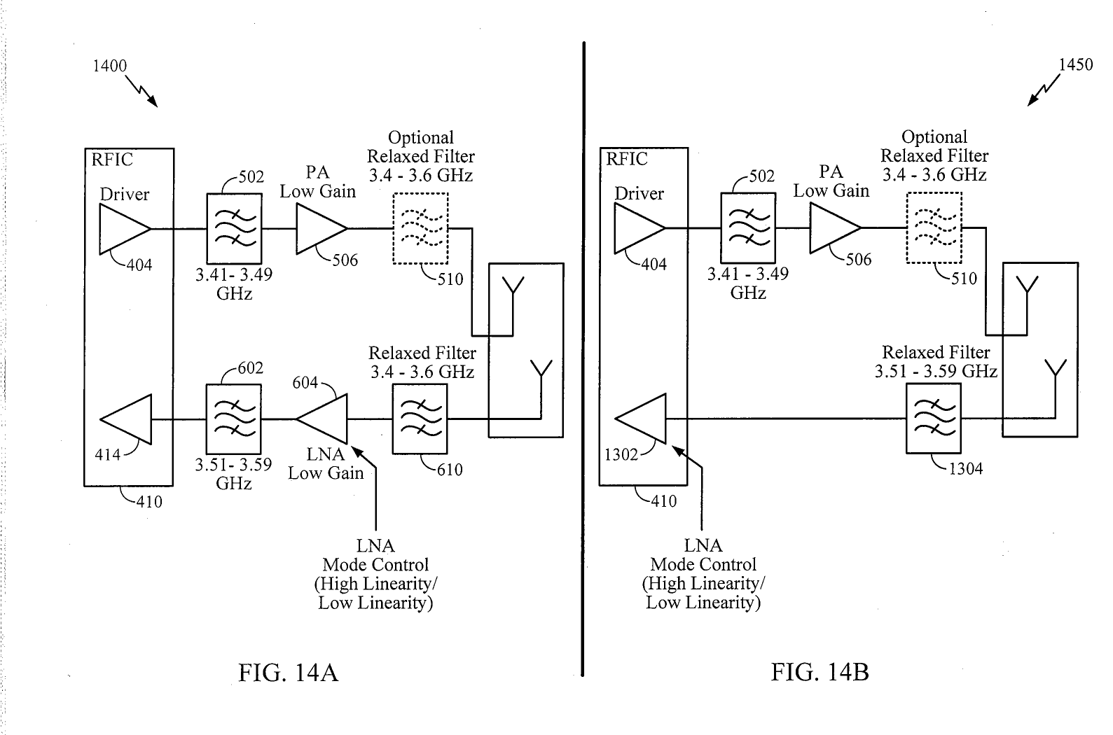

FIG. 14A illustrates an example RFFE block diagram 1400 using distributed Tx/Rx paths for an LTE B22 FDD split system with a 20 MHz duplex band gap, in accordance with certain aspects of the present disclosure. The RFFE block diagram 1400 of FIG. 14A is similar to the RFFE block diagram 700 of FIG. 7.

FIG. 14B illustrates an example RFFE block diagram 1450 using a distributed Tx path for an LTE B22 FDD split system with a 20 MHz duplex band gap, in accordance with certain aspects of the present disclosure. In other words, the Rx path is not distributed in FIG. 14B. The RFFE block diagram 1450 of FIG. 14B is similar to the RFFE block diagram 1300 of FIG. 13. According to certain aspects, the tuning circuits 1202, 1204 may be added to the RFFE block diagram 1450.

For FIGS. 14A and 14B, a duplex band gap of 20 MHz may provide sufficient Rx/Tx antenna isolation. For certain aspects, a tuned antenna (not shown) may increase isolation. Furthermore, filter design constraints are more feasible with a 20 MHz band gap. A single filter or a divided filter with overlapping frequency bands may be employed.

### An Example FDD/TDD Dual Antenna Split Front-End

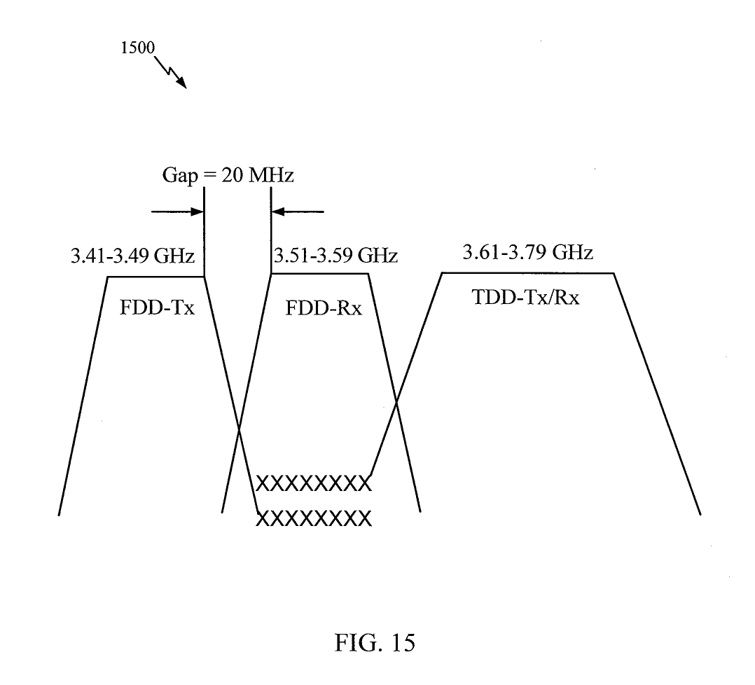

FIG. 15 illustrates example frequency bands 1500 for coexistence of frequency division duplexing (FDD) and time division duplexing (TDD) in a LTE 3.5 GHz system, in accordance with certain aspects of the present disclosure. FIG. 15 illustrates a FDD-Tx frequency band ranging from 3.41 to 3.49 GHz, a FDD-Rx frequency band ranging from 3.51 to 3.59 GHz, and a TDD-Tx/Rx frequency band ranging from 3.61 to 3.79 GHz. There may be a small frequency gap between the bands, such as the 20 MHz band gap illustrated between the FDD-Tx and FDD-RX bands.

High cellular frequency bands, such as LTE 3.5 GHz with a dual FDD/TDD scheme, pose very challenging problems due to severe realization difficulties. There may be a small frequency gap between systems, and the emission mask may be of considerable importance for FDD/TDD coexistence. FDD full duplex (FDD-FD) may have a potential problem of self-jamming (de-sense), especially at high output power. Furthermore, SAW, BAR, and FBAR filters with high rejection in a small band gap may be difficult to realize and the cutoff frequencies may be susceptible to temperature drift. An integrated FDD-FD and TDD solution is very difficult to realize, and low PA efficiency is yet another problem.

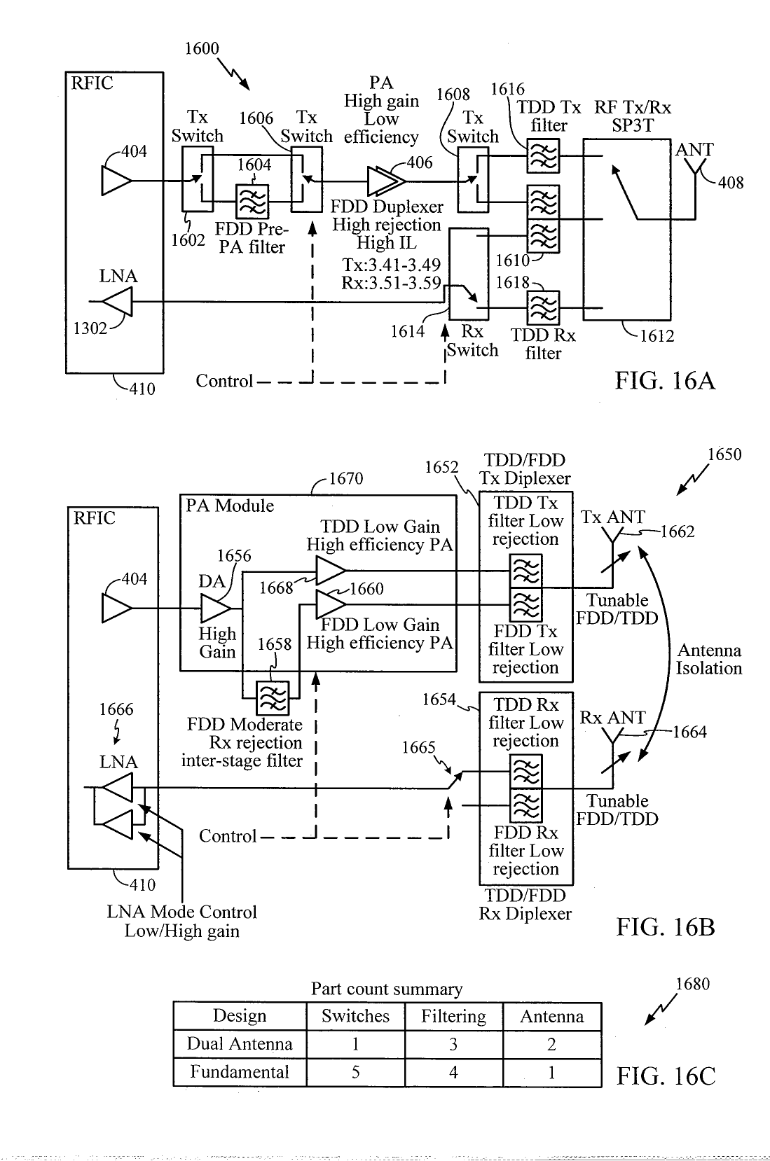

FIG. 16A illustrates an example RFFE block diagram 1600 for FDD/TDD coexistence using a common antenna 408, in accordance with certain aspects of the present disclosure. For FDD-Tx operation, a first Tx switch 1602 may direct the output of the PA driver 404 to a FDD pre-PA filter 1604 (e.g., a BPF). A second Tx switch 1606 may direct the output of the FDD pre-PA filter 1604 to the PA 406, which may be a cascaded PA. The cascaded PA may have high gain, but may suffer from low efficiency. A third Tx switch 1608 may direct the amplified signals from the PA 406 to a FDD duplexer 1610, and an RF Tx/Rx SP3T switch 1612 controlled to select the middle port may direct the filtered output of the duplexer 1610 to the common antenna 408 for transmission.

For FDD-Rx operation, signals received by the common antenna 408 may be directed by the RF Tx/Rx SP3T switch 1612 to the duplexer 1610, which isolates the FDD-Tx path from the FDD-Rx path, but allows the paths to share the common antenna 408. For certain aspects, the FDD duplexer 1610 may use the FDD-Tx and FDD-Rx frequency bands illustrated in FIG. 15. The received signals filtered by the duplexer 1610 may be directed by an Rx switch 1614 to the LNA 1302, which may reside on the RFIC 410 for certain aspects.

For TDD-Tx operation, the first and second Tx switches 1602, 1606 may direct the output of the PA driver, which may reside on the RFIC 410 for certain aspects, to the PA 406. The third Tx switch 1608 may direct the amplified signals output from the PA 406 to a TDD Tx filter 1616 (e.g., a BPF implementing the TDD-Tx/Rx frequency band of FIG. 15). The RF Tx/Rx SP3T switch 1612 controlled to select the uppermost port may direct the filtered signals from the TDD Tx filter 1616 to the common antenna for transmission during predetermined transmission intervals.

For TDD-Rx operation, signals received by the common antenna 408 during predetermined reception intervals may be directed by the RF Tx/Rx SP3T switch 1612 to a TDD Rx filter 1618 (e.g., a BPF implementing the TDD-Tx/Rx frequency band of FIG. 15). The Rx switch 1614 may direct the filtered signals from the TDD Rx filter 1618 to the LNA 1302 for amplification and further processing.

FIG. 16B illustrates an example dual antenna RFFE block diagram 1650 for FDD/TDD coexistence using a distributed transmitter and two diplexers 1652, 1654, in accordance with certain aspects of the present disclosure. For FDD-Tx operation, a high gain driver amplifier (DA) 1656 may amplify the output of the PA driver 404. The output of the DA 1656 may be filtered by a FDD inter-stage filter 1658 (e.g., a BPF with moderate rejection). The filtered signals from the FDD inter-stage filter 1658 may be amplified by a FDD PA 1660, which may be a low gain, high efficiency PA for certain aspects. The amplified signals from the FDD PA 1660 may be filtered by a TDD/FDD Tx diplexer 1652 before being transmitted by a (tunable) Tx antenna 1662.

For FDD-Rx operation, signals received by a (tunable) Rx antenna 1664 may be filtered by a TDD/FDD Rx diplexer 1654. An Rx switch 1665 may be controlled to direct the filtered signals to a dual-mode LNA 1666, which may reside on the RFIC 410 for certain aspects. The dual-mode LNA 1666 may be controlled to select between low gain and high gain modes.

For TDD-Tx operation in the RFFE block diagram 1650, the output of the high gain DA 1656 may be amplified by a TDD PA 1668. The TDD PA 1668 may have low gain and high efficiency for certain aspects. The amplified output of the TDD PA 1668 may be filtered by the TDD/FDD Tx diplexer 1652 before being transmitted by the (tunable) Tx antenna 1662. For certain aspects, the TDD PA 1668, the FDD PA 1660, and the DA 1656 may reside on a PA module 1670. The FDD inter-stage filter 1658 may be external to the PA module 1670.

For TDD-Rx operation, signals received by the (tunable) Rx antenna 1664 may be filtered by the TDD/FDD Rx diplexer 1654. The Rx switch 1665 may be controlled to direct the filtered signals to the dual-mode LNA 1666 for amplification and further processing.

FIG. 16C is a table 1680 illustrating a part count summary for the RFFE block diagrams of FIGS. 16A and 16B, in accordance with certain aspects of the present disclosure. The RFFE block diagram 1600 uses 5 switches, 4 filters (if the duplexer 1610 is counted as one filter), and only a single antenna. In contrast, the RFFE block diagram 1650 of FIG. 16B uses a single switch, 3 filters (if the diplexers are each counted as one filter), and 2 antennas. Therefore, the dual-antenna distributed RFFE solution of FIG. 16B using the diplexers 1652, 1654 and a dual-mode LNA 1666 saves Tx switches and reduces transmit power. Furthermore, many of the BPF specifications may be relaxed with the integrated FDD-FD/TDD architecture of FIG. 16B.

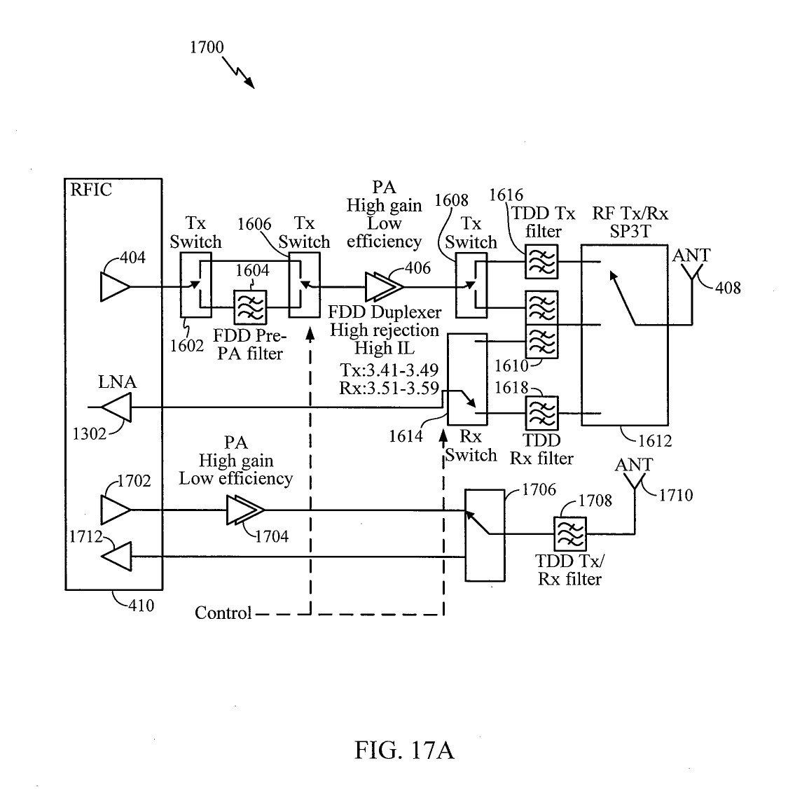

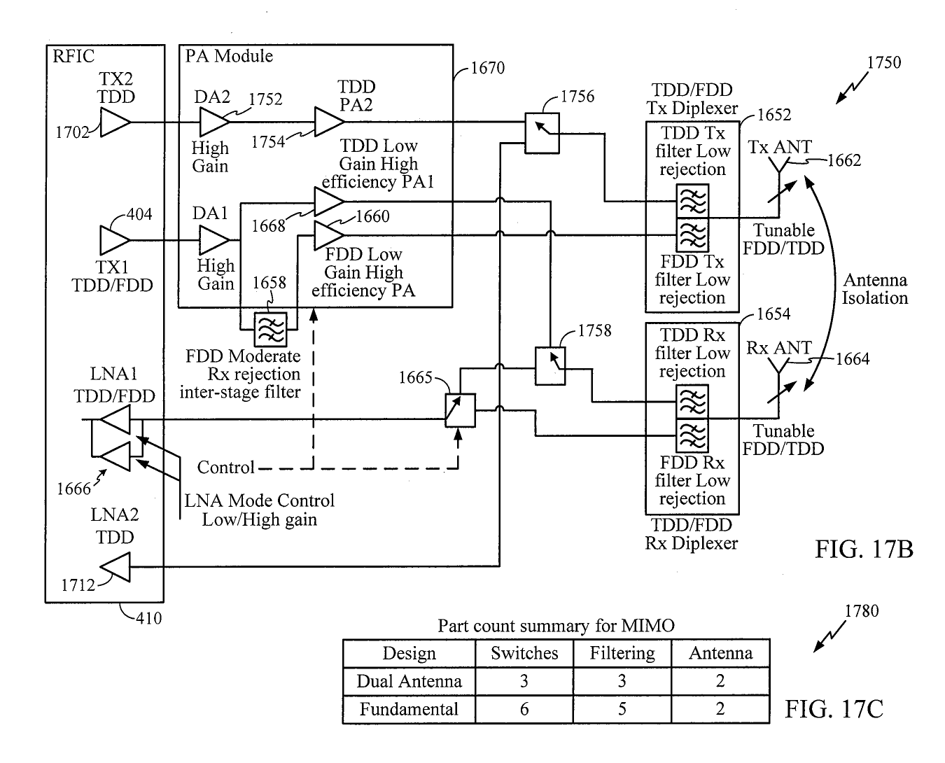

FIG. 17A illustrates an example RFFE block diagram 1700 for FDD/TDD MIMO (multiple input multiple output) coexistence, expanding on the RFFE block diagram 1600 of FIG. 16A, in accordance with certain aspects of the present disclosure. For TDD MIMO Tx operation, the RFFE block diagram 1700 adds a second PA driver 1702 for driving a second PA 1704. Like the PA 406, the second PA 1704 may be a cascaded PA, which may provide high gain, but low efficiency. A switch 1706 may direct the amplified output of the second PA 1704 to a TDD Tx/Rx filter 1708 (e.g., a BPF), and the filtered output of the TDD Tx/Rx filter 1708 may be transmitted from a second antenna 1710 during predetermined transmission intervals.

For TDD MIMO Rx operation, signals received by the second antenna 1710 during predetermined reception intervals may be filtered by the TDD Tx/Rx filter 1708. The switch 1706 may direct the filtered signals from the TDD Tx/Rx filter 1708 to a second LNA 1712 for amplification and further processing.

FIG. 17B illustrates an example RFFE block diagram 1750 for FDD/TDD MIMO coexistence using two diplexers 1652, 1654, expanding on the RFFE block diagram 1650 of FIG. 16B, in accordance with certain aspects of the present disclosure. For TDD MIMO Tx operation, the RFFE block diagram 1750 adds a second PA driver 1702 for driving a second driver amplifier (DA) 1752, whose amplified signals are further amplified by a second TDD PA 1754. For certain aspects, the second DA 1752 and the second TDD PA 1754 may reside on the PA module 1670. A switch 1756 may direct the amplified output of the second TDD PA 1754 to the TDD/FDD Tx diplexer 1652, and the filtered output of the TDD/FDD Tx diplexer 1652 may be transmitted from the (tunable) Tx antenna 1662 during predetermined transmission intervals.

The RFFE block diagram 1750 may also include a switch 1758 for directing the output of the first TDD PA 1668 to the TDD/FDD Rx diplexer 1654 for filtering before being transmitted by the (tunable) Rx antenna 1664 during the predetermined transmission intervals.

For TDD MIMO Rx operation, signals received by the (tunable) Tx antenna 1662 during predetermined reception intervals may be filtered by the TDD/FDD Tx diplexer 1652. The switch 1756 may direct the filtered signals from the TDD/FDD Tx diplexer 1652 to a second LNA 1712 for amplification and further processing. Signals received by the (tunable) Rx antenna 1664 during the predetermined reception intervals may be filtered by the TDD/FDD Rx diplexer 1654. The switches 1758, 1665 may direct the filtered signals from the TDD/FDD Rx diplexer 1654 to the LNA 1666 for amplification and further processing. In this manner, the switch 1758 is used to select between TDD-Tx and TDD-Rx operations. The switch 1665 is used to select between TDD-Rx and FDD-Rx operations.

Therefore, the simultaneous FDD/TDD MIMO split FE solution of FIG. 17B enables using TDD MIMO by adding only two switches to the RFFE block diagram of FIG. 16B. The FDD path remains unchanged from the RFFE block diagram of FIG. 16B, driven to the Tx/Rx antennas via the diplexers 1652, 1654. This architecture also supports dual Tx mode operation (FDD/TDD) at the same time.

FIG. 17C is a table 1780 illustrating a part count summary for comparing part counts between the RFFE block diagrams of FIGS. 17A and 17B, in accordance with certain aspects of the present disclosure. The RFFE block diagram 1700 uses 6 switches, 5 filters (if the duplexer 1610 is counted as one filter), and 2 antennas. In contrast, the RFFE block diagram 1750 of FIG. 17B uses 3 switches, 3 filters (if the diplexers are each counted as one filter), and 2 antennas.

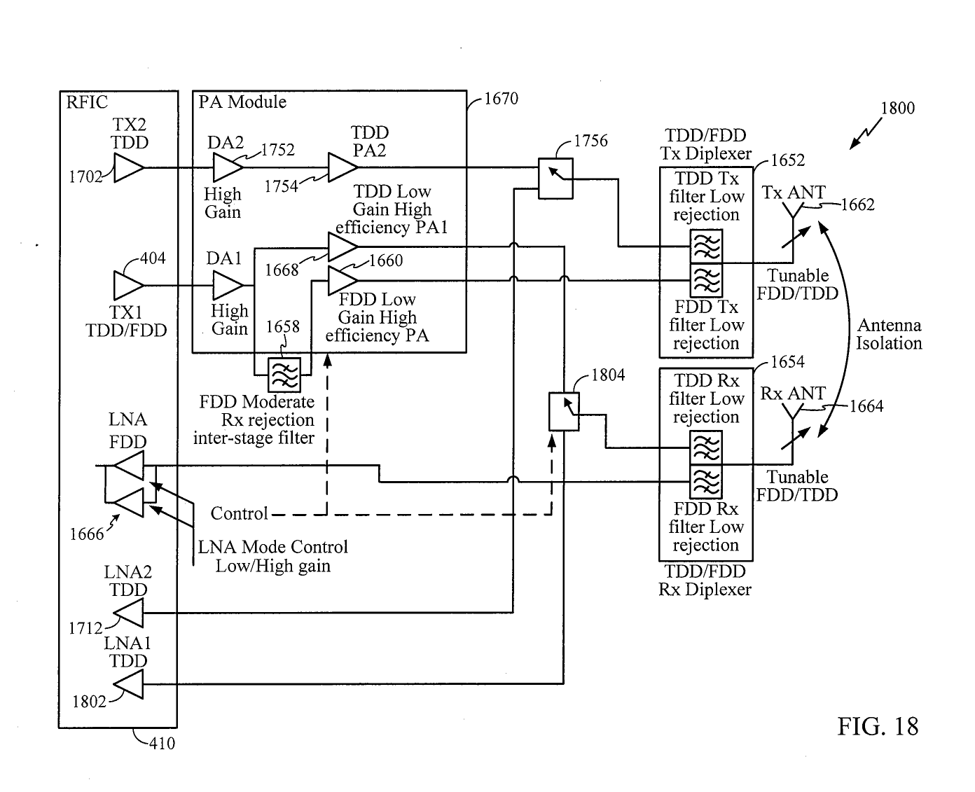

FIG. 18 illustrates an example RFFE block diagram 1800 for FDD/TDD MIMO coexistence using two diplexers, as an alternative to the RFFE block diagram 1750 of FIG. 17B, in accordance with certain aspects of the present disclosure. Rather than using the LNA 1666 as a combined TDD/FDD LNA, the RFFE block diagram 1800 of FIG. 18 introduces another dedicated TDD LNA 1802 (labeled “LNA1 TDD”) and replaces switches 1758, 1665 with switch 1804. This effectively reduces the part count, may reduce the IL, and may improve the Rx NF compared to the RFFE block diagram 1750. In the RFFE block diagram 1800 of FIG. 18, the switch 1804 may be controlled to select between TDD-Tx and TDD-Rx operations.

The RFFE block diagrams 1650, 1750, and 1800 of FIGS. 16B, 17B, and 18 offer several advantages over conventional RFFE topologies. The diplex combining of TDD and FDD Tx/Rx paths to the dual antennas without switches reduces the front end insertion loss (IL). These architectures not only provide for FDD/TDD coexistence, but also reduce self de-sensitization. With the integrated dual mode FDD/TDD solutions described above, small inter-Tx/Rx FDD band gaps and FDD/TDD band gaps (such as 10 MHz or 20 MHz) may be realized. The FDD-FD RFFE realization technology limitations are overcome by integration of the dual tunable Tx/Rx antennas, the distributed Rx/Tx lineup (amplifiers and filters), and the dual-mode LNA (selecting between high linearity and low linearity).

The solutions supporting FDD/TDD MIMO coexistence in the RFFE block diagrams 1750, 1800 are simplified and involve lower part count and decreased circuit board area compared to the RFFE block diagram 1700 of FIG. 17A. Although only one or two switches are added to the single input single output (SISO) RFFE block diagram 1700, all of the following are supported by the RFFE block diagrams 1750, 1800 of FIGS. 17B and 18: (1) FDD-FD (e.g., LTE B22 3.41-3.49 GHz), (2) TDD SISO (e.g., LTE B42 3.6-3.8 GHz), (3) TDD MIMO (e.g., LTE B42 3.6-3.8 GHz), and (4) FDD/TDD simultaneous operation (e.g., LTE B22 and B42).

The RFFE block diagrams 1650, 1750, and 1800 permit exploiting two 80 MHz bands with a 20 MHz band gap, in addition to a more typical two 70 MHz bands with a 30 MHz band gap. Therefore, bandwidth is increased, which leads to higher data rates being achieved. Furthermore, the efficient dual mode FDD/TDD hardware architecture solves both the coexistence and self de-sense problems, solving the Tx mask and spectral re-growth for TDD, especially for FDD-FD. For TDD, the RFFE block diagrams described herein provide for Tx power reduction due to the switchless diplexer TDD/FDD combining to the Tx antenna. For FDD-FD, the RFFE block diagrams described herein provide for Tx power reduction due to lower post-PA filter IL (with lower rejection design constraints) and a switchless FDD-TDD Tx antenna feed.

The RFFE block diagrams 1650, 1750, and 1800 allow optimizing the Tx and Rx chains per system/band. PA efficiency may be increased by using a common driver amplifier and a low gain PA stage for each system (e.g., each PA is optimized per its frequency band). Antenna efficiency may be increased by using narrow band, tunable Tx/Rx antennas per system and per Tx and Rx bands. Power consumption may also be optimized per band (PA and antenna).

Moreover, the integrated FDD/TDD solutions in the RFFE block diagrams 1650, 1750, and 1800 offer reduced part count (e.g., 1 switch in FIG. 16B compared to 5 switches in FIG. 16A) and decreased cost. The RFFE block diagrams 1650, 1750, and 1800 provide a solution for Tx/Rx isolation in FDD-FD operation with a small Tx/Rx band gap and permit the use of relaxed filter rejections with less stringent design constraints for temperature drift, especially for the case of FDD-FD with small Tx/Rx band gap. Last, but not least, Rx NF may be improved, and the Tx current reduction increases battery time for user equipment.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof; may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
first and second power amplifiers (PAs) for amplifying signals for transmission;
a transmit antenna for transmitting the amplified signals;
a receive antenna for receiving other signals to be processed in a receive path; and
a first transmit filter configured to filter the amplified signals from the first PA before amplification by the second PA.

2. The apparatus of claim 1, further comprising a second transmit filter configured to filter the amplified signals from the second PA before transmission by the transmit antenna.

3. The apparatus of claim 2, wherein the second transmit filter has more relaxed rejection than the first transmit filter.

4. The apparatus of claim 2, wherein the second transmit filter has low insertion loss.

5. The apparatus of claim 1, wherein the second PA is a low gain PA.

6. The apparatus of claim 1, wherein the first transmit filter comprises a divided filter, wherein the divided filter comprises:
at least two selectable filters; and
at least one switch for selecting between the at least two selectable filters.

7. The apparatus of claim 6, wherein the at least two selectable filters have overlapping passbands.

8. The apparatus of claim 6, wherein the at least two selectable filters comprise at least one of a surface acoustic wave (SAW) filter, a bulk acoustic wave (BAW) filter, a thin film bulk acoustic resonator (FBAR) filter, or an inductor-capacitor (LC) filter.

9. The apparatus of claim 1, wherein the transmit antenna is a tunable transmit antenna.

10. The apparatus of claim 1, further comprising a notch filter configured to filter the amplified signals from the first PA before amplification by the second PA.

11. The apparatus of claim 10, wherein the notch filter is a tunable notch filter.

12. The apparatus of claim 1, wherein the first transmit filter comprises a notch filter.

13. The apparatus of claim 1, wherein the receive path comprises:
first and second low noise amplifiers (LNAs) for amplifying the other signals received by the receive antenna; and
a first receive filter configured to filter the amplified other signals from the first LNA before amplification by the second LNA.

14. The apparatus of claim 13, further comprising a second receive filter configured to filter the other signals received by the receive antenna before amplification by the first LNA.

15. The apparatus of claim 14, wherein the second receive filter has more relaxed rejection than the first receive filter.

16. The apparatus of claim 14, wherein the second receive filter has low insertion loss.

17. The apparatus of claim 13, wherein the first LNA is a low gain LNA.

18. The apparatus of claim 13, wherein the first receive filter comprises a divided filter, wherein the divided filter comprises:
at least two selectable filters; and
at least one switch for selecting between the at least two selectable filters.

19. The apparatus of claim 18, wherein the at least two selectable filters have overlapping passbands.

20. The apparatus of claim 18, wherein the at least two filters comprise at least one of a surface acoustic wave (SAW) filter, a bulk acoustic wave (BAW) filter, a thin film bulk acoustic resonator (FBAR) filter, or an inductor-capacitor (LC) filter.

21. The apparatus of claim 13, further comprising a notch filter configured to filter the amplified other signals from the first LNA before amplification by the second LNA.

22. The apparatus of claim 21, wherein the notch filter is a tunable notch filter.

23. The apparatus of claim 13, wherein the first receive filter comprises a notch filter.

24. The apparatus of claim 1, wherein the receive path comprises:
a first receive filter configured to filter the other signals received by the receive antenna; and
a low noise amplifier (LNA) for amplifying the filtered other signals.

25. The apparatus of claim 1, wherein the receive antenna is a tunable receive antenna.

26. The apparatus of claim 1, wherein the apparatus supports long-term evolution (LTE) B22 (3.5 GHz band) with frequency division duplexing (FDD).

27. The apparatus of claim 1, wherein the apparatus supports a frequency division duplexing (FDD) band gap of about 10 MHz.

28. The apparatus of claim 1, wherein the transmit antenna is isolated from the receive antenna by at least 15 dB.

29. The apparatus of claim 1, further comprising a transmit diplexer configured to frequency-domain multiplex inputs to first and second ports onto a third port, wherein the first port receives the amplified signals from the second PA and wherein the third port is coupled to the transmit antenna.

30. The apparatus of claim 29, further comprising a third PA for amplifying the amplified signals from the first PA, wherein the amplified signals from the third PA are sent to the second port of the transmit diplexer.

31. The apparatus of claim 30, wherein the first transmit filter, the second PA, and a second transmit filter coupled between the first and third ports of the transmit diplexer form a first transmit path that supports frequency-division duplex (FDD) transmission and wherein the third PA and a third transmit filter coupled between the second and third ports of the transmit diplexer form a second transmit path that supports time-division duplexing (TDD).

32. The apparatus of claim 30, wherein the first transmit path supports the FDD transmission in a first range from about 3.41 to about 3.49 GHz and wherein the second transmit path supports the TDD in a second range from about 3.6 to about 3.8 GHz.

33. The apparatus of claim 32, wherein the receive path supports FDD reception in a third range from about 3.51 to about 3.59 GHz.

34. The apparatus of claim 1, further comprising a receive diplexer having first and second ports and configured to frequency-domain de-multiplex an input to a third port onto the first and second ports, wherein the third port receives the other signals from the receive antenna.

35. The apparatus of claim 34, wherein the receive path comprises:
a switch for selecting between the first and second ports of the receive diplexer; and
at least one low noise amplifier (LNA) for amplifying the other signals received via the selected one of the first and second ports.

36. The apparatus of claim 35, wherein the receive path and a first receive filter coupled between the first and third ports of the receive diplexer support frequency-division duplex (FDD) reception in a first range from about 3.51 to 3.59 GHz and wherein the receive path and a second receive filter coupled between the second and third ports of the receive diplexer support time-division duplexing (TDD) in a second range from about 3.6 to 3.8 GHz.

37. An apparatus for wireless communications, comprising:
a receive antenna for receiving signals;
a transmit antenna for transmitting other signals processed in a transmission path;
first and second low noise amplifiers (LNAs) for amplifying the signals received by the receive antenna; and
a first receive filter configured to filter the amplified signals from the first LNA before amplification by the second LNA.

38. The apparatus of claim 37, further comprising a second receive filter configured to filter the signals received by the receive antenna before amplification by the first LNA.

39. The apparatus of claim 38, wherein the second receive filter has more relaxed rejection than the first receive filter.

40. The apparatus of claim 38, wherein the second receive filter has low insertion loss.

41. The apparatus of claim 37, wherein the first LNA is a low gain LNA.

42. The apparatus of claim 37, wherein the first receive filter comprises a divided filter, wherein the divided filter comprises:
at least two selectable filters; and
at least one switch for selecting between the at least two selectable filters.

43. The apparatus of claim 42, wherein the at least two selectable filters have overlapping passbands.

44. The apparatus of claim 42, wherein the at least two selectable filters comprise at least one of a surface acoustic wave (SAW) filter, a bulk acoustic wave (BAW) filter, a thin film bulk acoustic resonator (FBAR) filter, or an inductor-capacitor (LC) filter.

45. The apparatus of claim 37, further comprising a notch filter configured to filter the amplified signals from the first LNA before amplification by the second LNA.

46. The apparatus of claim 45, wherein the notch filter is a tunable notch filter.

47. The apparatus of claim 37, wherein the first receive filter comprises a notch filter.

48. The apparatus of claim 37, wherein the receive antenna is a tunable receive antenna.

49. The apparatus of claim 37, wherein the apparatus supports long-term evolution (LTE) B22 (3.5 GHz band) with frequency division duplexing (FDD).

50. The apparatus of claim 37, wherein the apparatus supports a frequency division duplexing (FDD) band gap of about 10 MHz.

51. The apparatus of claim 37, wherein the transmit antenna is isolated from the receive antenna by at least 15 dB.

52. An apparatus for wireless communications, comprising:
a first driver amplifier (DA) for amplifying signals for transmission;
a transmit filter for filtering the amplified signals from the first DA;
a first power amplifier (PA) for amplifying the filtered signals from the transmit filter;
a first diplexer configured to frequency-domain multiplex inputs to first and second ports onto a third port, wherein the first port receives the amplified signals from the first PA;
a first antenna coupled to the first PA via a first diplexer; and
a second antenna coupled to a receive path via a second diplexer.

53. The apparatus of claim 52, wherein the first diplexer is configured to frequency-domain multiplex inputs to first and second ports onto a third port, wherein the first port receives the amplified signals from the first PA and wherein the third port is coupled to the first antenna.

54. The apparatus of claim 53, further comprising:
a second DA for amplifying other signals for transmission; and
a third PA for amplifying the amplified signals from the second DA, wherein the third PA is coupled to the second port of the first diplexer.

55. The apparatus of claim 54, further comprising:
a first low noise amplifier (LNA); and
a first switch for selecting between the third PA for transmission and the first LNA for reception, wherein the first switch is coupled to the second port of the first diplexer.

56. The apparatus of claim 55, wherein the receive path comprises a second LNA and wherein the second diplexer is configured to frequency-domain multiplex inputs to fourth and fifth ports onto a sixth port, wherein the sixth port is coupled to the second antenna and wherein the fourth port is coupled to the second LNA.

57. The apparatus of claim 56, further comprising:
a third LNA; and
a second switch for selecting between the second PA for transmission and the third LNA for reception, wherein the second switch is coupled to the fifth port of the second diplexer.

58. The apparatus of claim 56, further comprising:
a second switch interposed between the second LNA and the fourth port of the second diplexer; and
a third switch coupled to the fifth port of the second diplexer, wherein the third switch is for selecting between the second PA for transmission and the second switch for reception by the second LNA and wherein the second switch is for selecting between the fifth port, via the third switch, and the fourth port for reception.

59. The apparatus of claim 56, wherein the transmit filter, the first PA, and a portion of the first diplexer including the first port form a first transmit path that supports frequency-division duplex (FDD) transmission and wherein the receive path and a portion of the second diplexer including the fourth port support FDD reception.

60. The apparatus of claim 59, wherein the first transmit path supports the FDD transmission in a first range from about 3.41 to about 3.49 GHz and wherein the receive path and the portion of the second diplexer support the FDD reception in a second range from about 3.51 to about 3.59 GHz.

61. The apparatus of claim 59, wherein the third PA, the first switch, and another portion of the first diplexer including the second port support time-division duplex (TDD) transmission and wherein the first LNA, the first switch, and the portion of the first diplexer including the second port support TDD reception.

62. The apparatus of claim 61, wherein the apparatus supports the TDD transmission and the TDD reception in a third range from about 3.6 to about 3.8 GHz.

63. The apparatus of claim 61, wherein the apparatus supports the TDD transmission or the TDD reception simultaneously with the FDD transmission and the FDD reception.

64. The apparatus of claim 56, wherein the apparatus supports time-division duplexing (TDD) multiple input, multiple output (MIMO).

65. The apparatus of claim 56, wherein the second LNA comprises a dual-mode LNA.

66. The apparatus of claim 52, wherein the first DA has a higher gain than the first PA.

67. The apparatus of claim 52, wherein at least one of the first and second antennas is a tunable antenna.

68. The apparatus of claim 52, wherein the first antenna is isolated from the second antenna by at least 15 dB.

69. The apparatus of claim 52, wherein the apparatus supports a frequency-division duplexing (FDD) band gap of about 20 MHz.
